(19) United States
(12) Patent Application Publication
(10) Pub. No.: US 2008/0135227 A1
(43) Pub. Date: Jun. 12, 2008

(54) Heated separation vessel for well fluids

(75) Inventor: Les Unrau, Lloydminster (CA)

Correspondence Address: MILES & STOCKBRIDGE PC, 1751 PINNACLE DRIVE, SUITE 500, MCLEAN, VA, 22102-3833, US

(73) Assignee: Universal Industries Corp.

(21) Appl. No.: 11/987,389

(22) Filed: Nov. 29, 2007

(30) Foreign Application Priority Data
Dec. 8, 2006 (CA) 2570719

(51) Int. Cl. E21B 36/02; B01D 35/00; B01D 35/18; F22B 9/00; E21B 36/00

(52) U.S. Cl. 166/57; 122/44.1; 166/302; 210/175; 210/774

(57) ABSTRACT

An apparatus and method for separating the output fluids of a well by way of efficiently applying heat to the fluids. Separation takes place in a sealed vessel to which heat is applied to the fluid by contact with a multi-pass firetube assembly through which hot exhaust gas is expelled from a forced draft burner. The firetubes forming the assembly are of smaller diameter than used in conventional separators and not subject to high leakage experienced in conventional separating vessels, and the heat transfer is highly efficient resulting in less fuel consumption and less emission of greenhouse gases.

### CROSSED REFERENCE TO RELATED APPLICATION

This application claims the benefit of convention priority on Canadian Patent Application No. 2,570,719, filed Dec. 8, 2006 entitled Heated Separation System For Well Fluids.

### FIELD OF THE INVENTION

This invention relates to the gravity treating of fluid such as produced oil and water from a well, and more particularly, to a heating system for applying heat to the fluids to enhance separation.

### BACKGROUND OF THE INVENTION

Various types of separation systems are presently used in oil field facilities at the well head where oil, water and natural gas occur together naturally.

A common type of such a system uses a treating vessel wherein the produced fluids of a well slowly travel through the vessel in order to basically allow the water to sink and the oil to float. The fluid properties determine the amount of resident time required for separation. Baffles and the like along the path of flow are commonly used to enhance this process, and again while properties of the fluids determines the amount of time required for separation, it is not unknown to utilize the addition of heat to the fluids as well to accelerate the separation.

As indicated, such systems are used in field facilities where oil, water and natural gas occur together, and thus, in known systems natural gas, which was otherwise considered as being a waste, has been utilized to fire relatively small natural draft burners for heating the fluids. The efficiency of such natural draft burners was considered irrelevant because the fluid gas was in the past a waste product. Over the past decade or so, however, the separating vessels have become much larger causing the heating requirement to significantly increase, and as a result, it is difficult in many operations for the field facilities to provide enough fuel gas to fire larger burners of the type used in the past. Moreover, because of more recent escalating prices of natural gas amounts of gases produced and previously considered to be a waste product is now considered a saleable commodity. Furthermore, government regulations have become more strict to the point it is difficult for the typical natural draft burner systems to meet such new standards.

Also, due to the nature of the known natural draft systems, which must utilize very large firetube diameters, such systems are known to encounter severe leakage characteristics and overall produce high amounts of greenhouse gases.

### SUMMARY OF THE INVENTION

It is an object of the present invention to provide in a separation vessel a heating system which provides more rapid and efficient heating of the fluids being separated without emitting significant greenhouse gases.

According to one aspect of the invention, there is provided a heating system in a separating apparatus for applying heat to fluids introduced from a well, the apparatus including a vessel defining an internal, sealed chamber provided with an inlet for the well fluids and outlets for separated fluids. The heating system includes a forced draft burner having a hot exhaust outlet, and a multi-pass firetube assembly disposed within the vessel and having an inlet connected to the exhaust outlet of the forced draft burner and an outlet end external of the vessel. The firetube assembly thereby forms a repeated exhaust gas flow path therethrough from the forced draft burner to the atmosphere via the outlet, thus providing external firetube surfaces within the vessel and exposed to the fluids for transfer of heat thereto.

Another aspect of the invention resides in a method of heating well fluids for separation at a well head site by introducing the fluids into a sealed inner chamber of a vessel and exposing the fluids to heat. The method includes the step of providing a multi-pass firetube assembly formed of continuously connected firetubes of relatively small diameter within the vessel to be exposed externally to the well fluids and having an inlet end and an outlet end external of the vessel, and wherein a forced draft burner having an exhaust gas outlet thereof is connected to the inlet end of the firetube assembly. The method includes the step of operating the forced draft burner to drive the exhaust gases thereof through the firetube assembly to thereby cause heat transfer from the exhaust gases of the forced burner to the well fluids.

### BRIEF DESCRIPTION OF DRAWINGS

FIG. 1 is a side view of the separation vessel incorporating the heating system of the present invention;

FIG. 2 is a partial side view of a known type of separating vessel incorporating a system commonly presently used in the field;

FIG. 3 is a side view of a portion of the vessel of FIG. 1 and showing in dashed lines the multi-pass firetube assembly of the present invention, and,

FIG. 4 is a cross section view taken through the separating vessel as indicated at 4-4 of FIG. 3.

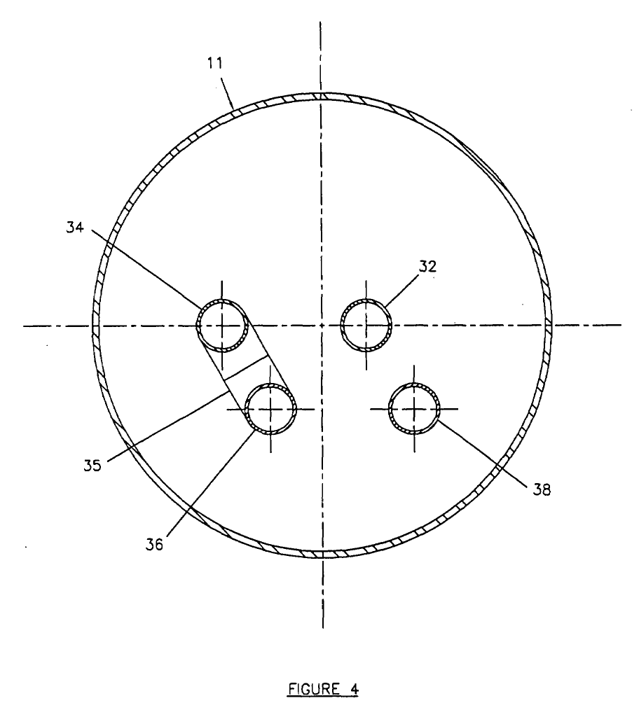

### DETAILED DESCRIPTION OF THE INVENTION

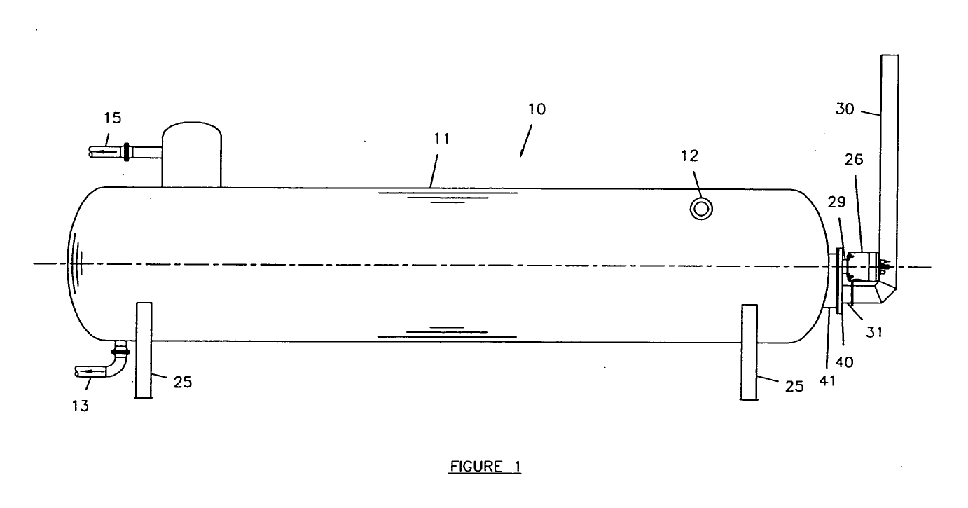

Referring first briefly to FIG. 1, it can be seen that there is present a separating unit 10 formed by an elongated, sealed vessel 11 of circular cross section to which is transferred from an adjacent well (not shown) production material which normally consists of oil, water, natural gas, and possibly other impurities through vessel pipe 12. After entering the vessel, the production materials flow towards the opposite end of the vessel during which separation of the constituents of well production occurs. Eventually, the fluids leave the vessel through separate outlets which includes oil and gas outlets shown as 13 and 15, respectively.

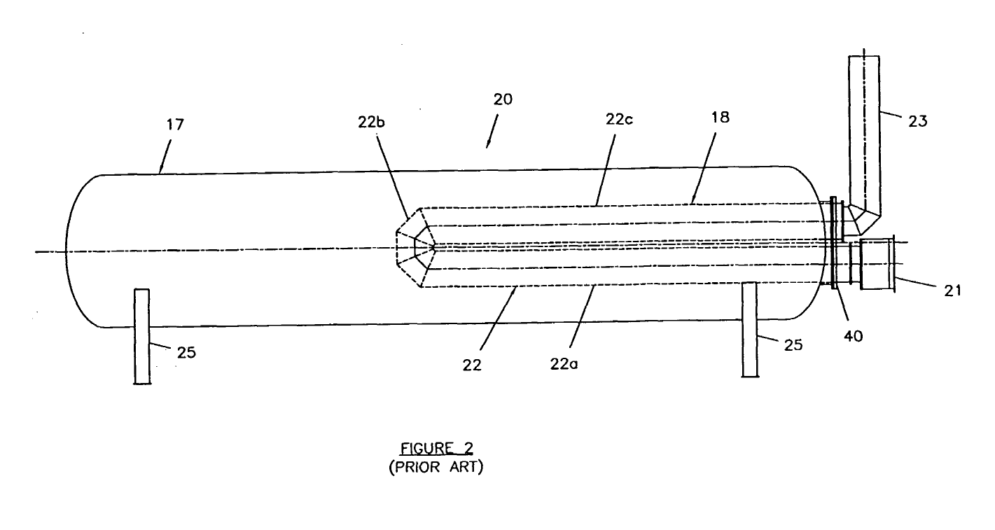

Returning now, however, to the features of the conventional natural draft burner system, reference is made to FIG. 2 of the drawings, wherein such a burner system is shown for adding heat to the separation process generally designated 17. The heating system thereof is generally designated 18 contained in an elongated separation vessel 20. A natural draft burner is designated 21 and is located externally of the vessel at one end thereof. Exhaust gas produced by burner 21 flows into one end of a firetube 22 at a first end projecting from the end of the vessel 20. The firetube is shown as being of a large diameter in order to permit the natural convention of the exhaust gases to pass through the single pass large diameter firetube consisting of a first flight 22a extending lengthwise within the vessel 17, and a U-turn connection 22b joined to a return flight 22c, which exits the end of the vessel 20 and is delivered to a stack 23.

As previously indicated, such natural gas burners used in the arrangement shown in FIG. 2, are inefficient, and for the amount of fuel consumed, the transfer of heat to the fluids within the vessel 17 is low. Subsequent to the original introduction of this known design the separation vessels have become much larger, with heating requirements becoming considerably greater to the extent that the facilities are unable to provide enough on site natural gas to fire these larger natural draft burners of conventional designs. Moreover, with the increase in price of natural gas the cost of operation is becoming prohibitive. Also, because of the lower efficiency of the large heat transfer firetube necessary in the use of the natural draft burner, high emissions are produced, typically 16,000 tonnes per year in CO₂ equivalent green house gases. In addition with the use of the large firetube diameters required with the natural draft burner, acceptable seals are very difficult, if not impossible to achieve in many cases. While it has been found that most users of the conventional system are prepared to accept some leakage, as a result of these other above described features of the now commonly used natural draft systems, it is becoming difficult for the users to meet the newer and stricter government standards.

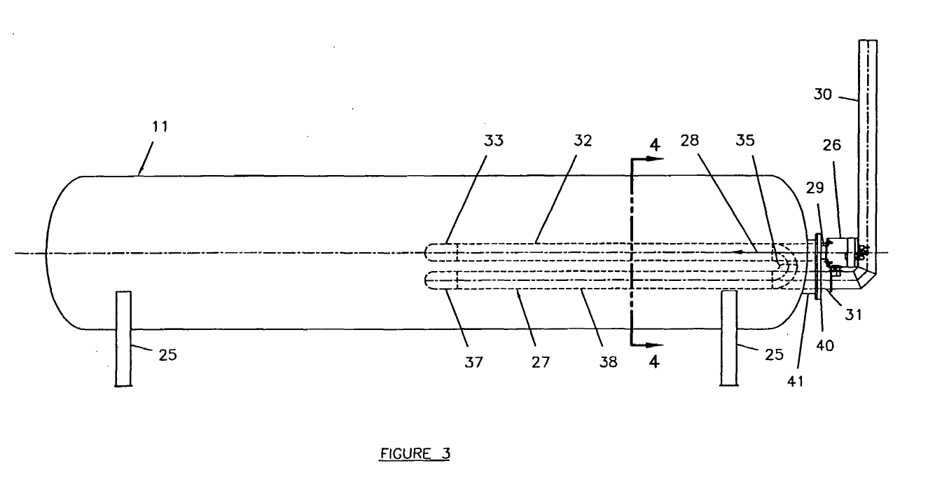

Returning now to the present invention as illustrated in FIGS. 1 and 3, it can be seen that the elongated cylindrically shaped vessel 11 is mounted on supports 25,25 for installation near a well head site (not shown). The product flow from the well enters the vessel through a line or inlet pipe 12, (FIG. 1) and flows towards the outlet end of the vessel during which time the oil and water content of the well output, which are in contact with the firetubes within the vessel, are separated and discharged separately from the vessel. Increasing the temperatures of the production flow towards the output end enhances separation, and thus the efficient transfer of heat from the exhaust gases produced by a forced draft burner 26, is essential to a more rapid rate of separation.

The hot exhaust issuing from forced draft burner 26 is injected into an inlet end 29 of a multi-pass firetube assembly 27 (FIG. 3) as indicated by arrow 28. After passing through the firetube assembly 27, the then relatively cooled exhaust gases pass to atmosphere through an exhaust stack 30 which is connected to an outlet end of the multi-pass firetube assembly 27. An important feature of the present invention is that in use with the forced draft burner 26, in the exhaust gases are introduced into the inlet of the multi-pass firetube assembly 27 under significant pressure, thus making possible the use of a firetube diameter of considerably smaller diameter than now commonly used in the field. Also because of the pressure produced at the outlet of the forced draft burner 26 at its connection to an inlet end of the firetube assembly 27, a much longer total length of firetube is possible. Accordingly, as illustrated, the firetube assembly is formed by multi-passes the separate flights of which are laterally and/or vertically spaced from each other for effect exposure to the outer circumferences of the different flights.

With reference to FIG. 3, it may be seen that the output of the forced draft burner 26 is directed into an inner end of a first flight or length 32 of the multi-pass firetube assembly 27, as indicated by arrow 28. At the extreme outer end the first flight 32, it is connected by a U-tube connecting firetube 33 to the outer end of a return flight 34. The inner end of the return firetube flight 34 is in turn connected to the inner end of firetube flight 36 by a U-tube connecting firetube 35. The outer end of the firetube flight 36 is connected by a U-tube connecting firetube 37 to a second return firetube flight 38, the inner end of which firetube 38 is connected to the exhaust stack 30 through outlet 31.

An initial inlet and outlet portion of 29 and 31 of the multi-pass firetube assembly pass through an end plate 40 which is bolted to and properly sealed to a flanged open ended portion 41 of the vessel 11. Thus, by providing an outwardly turned flange about the open-ended portion 41, a fastening system, such as a bolting arrangement may be provided for quick fastening and removal of the end plate 40 from the portion 41 whereby the forced draft burner 26, exhaust stack 30 as well as the inner end of the multi-pass firetube assembly 27, at one end, is supported by the vessel. Along the length of the multi-pass firetube assembly 27 individual supporting structures (not shown) are provided within the vessel 11. The arrangement of the firetube assembly is thus such that by removing the end plate 40, the entire heating unit, including the forced draft burner 26, multi-pass firetube assembly 27 and exhaust stack 30 can be removed as a unit from the vessel for any required maintenance to or overall replacement of the assembly can be carried out.

Operation of the heating system of the present invention has shown to be highly efficient in relation to the conventional system described herein, and avoids serious problems of leakage as described in relation to units now in use. For example, as compared with green house gas emissions indicated above in relation to the conventional unit, test indications are that the emissions of the heating system of the present invention will be in the order of 6,700 tonnes per year. Additionally the more efficient combustion and heat transfer to the separation fluids results in faster separation and significant savings in gas consumption. Maintenance costs are also reduced, and more efficient separation of the products of the well are achieved with the higher heat transfer rate to the products.

While a single embodiment of the invention has been shown and described, variations within the spirit of the present invention as defined in the accompanying claims will be obvious to those skilled in the art.

1. A heating system in a separating apparatus for applying heat to fluids introduced to said unit from a well;
said apparatus including a vessel defining an internal sealed chamber provided with an inlet for the well fluids and outlets for separated fluids,
said heating system comprising;
a forced draft burner having a hot exhaust outlet;
a multi-pass firetube assembly disposed within said vessel and having an inlet connected to said exhaust outlet of said forced draft burner and an outlet end external of said vessel,
said firetube assembly thereby forming a repeated exhaust gas flow path therethrough from said forced draft burner to atmosphere via said outlet end, and providing external surfaces within said vessel and exposed to said fluids for transfer of heat thereto.

2. A system as defined in claim 1, wherein;
said vessel includes an elongated cylindrical body having an opening at one end thereof defined by a first attachment portion, and
said firetube assembly includes a closure plate forming a second attachment portion engageable with said first attachment portion for closure of said opening;
said firetube assembly having a plurality of lengths of firetubes carried by and projecting from an inner surface of said closure plate to thereby extend into said elongated body when said closure plate is in a closed position, said plurality of lengths being grouped in a manner for longitudinal passage through said opening of said vessel during opening or closure of said closure plate.

3. A system as defined in claim 2, and including a cooled exhaust outlet stack connected outwardly to said closure plate, and
wherein said closure plate is provided with:
a first passage member for providing an inlet opening through said closure plate for passage of hot gases from said forced draft burners to an inlet end of a first length of said firetubes; and
a second passage member for providing an outlet from an inner outlet end of a last length of said firetubes to said outlet stack

4. A system as defined in claim 3, wherein;
said first length of firetube within said vessel has an outer outlet end opposite to said inlet end connected to an outer inlet end of a second length of said firetubes for flow of said hot gases from said first length into the outer inlet end of said second length, said second length in turn being connected to an inner inlet end of a third length; a second from the last length of said firetube assembly having an outer outlet end connected to said outer inlet end of said last length, whereby a continuous flow is provided from the inlet opening of said closure plate to said second passage member of said closure plate.

5. In a method of heating well fluids for separation at a well head site by introducing said well fluids into a sealed inner chamber of a vessel and exposing said well fluids to heat,
said method including the steps of;
providing
i) a multi-pass firetube assembly formed of continuously connected firetubes of relatively small diameter within said vessel to be exposed externally to said well fluids and having an inlet end and an outlet end external of said vessel,
ii) a forced draft burner having the exhaust gas outlet connected to said inlet end of said firetube assembly; and
operating said forced draft burner to drive the exhaust gases thereof through said firetube assembly to thereby cause heat transfer from said exhaust gases of said forced burner to the well fluids.
